(19) United States
(12) Patent Application Publication
(10) Pub. No.: US 2009/0215760 A1
(43) Pub. Date: Aug. 27, 2009

(54) SYNERGISTIC INSECTICIDE MIXTURES

(76) Inventors: Heike Hungenberg, Langenfeld (DE); Wolfram Andersch, Bergisch Gladbach (DE); Woflgang Thierlert, Odenthal (DE); Jairo Melgarejo, Düsseldorf (DE)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/629,873

(22) PCT Filed: Jun. 9, 2005
(86) PCT No.: PCT/EP05/06177

§ 371 Date: Sep. 10, 2008

(30) Foreign Application Priority Data
Jun. 16, 2004 (DE) 102004028994.8
Aug. 6, 2004 (DE) 102004038329.4

(51) Int. Cl. A01N 43/88; A01N 43/56; A01N 43/40; A01N 37/18; A01P 7/00

(52) U.S. Cl. 514/229.2; 514/407; 514/341; 514/365; 514/357

(57) ABSTRACT

The invention relates to insecticidal mixtures, comprising ethiprole and at least one other known active substance, belonging to the neonicotinoid family as well as to the use of said mixtures for controlling animal pests.

The present invention concerns new active compound combinations which contain as active principles ethiprole and at least one further active compound from the series of neonicotinoids and which possess very good insecticidal properties.

It is already known that ethiprole can be used for the control of animal pests, especially insects. It is also known that neonicotinoids such as imidacloprid, thiacloprid, clothianidin, thiamethoxam, acetamiprid, nitenpyram and dinotefuran are suitable for the control of animal pests, especially insects.

The activity of these compounds is good, but in many cases leaves much to be desired at low application rates or against individual pests.

It has now been found that mixtures containing ethiprole and in each case at least one and preferably precisely one compound from the series of the neonocotinoids are synergistically active and are suitable for the control of animal pests. Because of this synergism significantly lower amounts of active compounds can be used, that is the action of the mixture is greater than the action of the individual components.

The compounds named are known.

Ethiprole has the structure

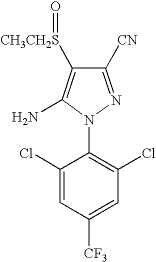

and is known from, for example, “The Pesticide Manual”, 13^{th} Edition, 2003, published by British Crop Protection Council, page 382.

Neonicotinoids may be described by the structure (I),

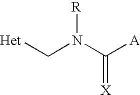

where
Het stands for a heterocyclic system selected from the following group of heterocycles: 2-chloropyrid-5-yl, 2-methylpyrid-5-yl, 1-oxido-3-pyridinio, 2-chloro-1-oxido-5-pyridinio, 2,3-dichloro-1-oxido-5-pyridinio, tetrahydrofuran-3-yl, 5-methyl-tetrahydrofuran-3-yl, 2-chlorothiazol-5-yl,
A stands for —N(R¹)(R²) or S(R²),
   where
   R¹ stands for hydrogen, C₁-C₆-alkyl, phenyl-C₁-C₄-alkyl, C₃-C₆-cycloalkyl, C₂-C₆-alkenyl or C₂-C₆-alkinyl, and
   R² stands for C₁-C₆-alkyl, C₂-C₆-alkenyl, C₂-C₆-alkinyl, —C(═O)—CH₃ or benzyl,
R stands for C₁-C₆-alkyl, C₂-C₆-alkenyl, C₂-C₆-alkinyl, —C(═O)—CH₃ or benzyl or together with R² for one of the following groups:
   —CH₂—CH₂—, —CH₂—CH₂—CH₂—, —CH₂—O—CH₂—, —CH₂—S—CH₂—, —CH₂—NH—CH₂—, —CH₂—N(CH₃)—CH₂— and
X stands for N—NO₂, N—CN or CH—NO₂,
   (see e.g. EP-A1-192 606, EP-A 2-580 533, EP-A 2-376 279, EP-A 2-235 725).

The following compounds are named individually:

Thiamethoxam has the structure

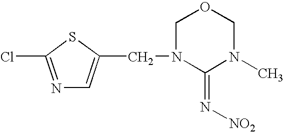

and is known from EP A2 0 580 553.

Clothianidin has the structure

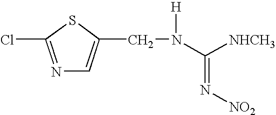

and is known from EP A2 0 376 279.

Thiacloprid has the structure

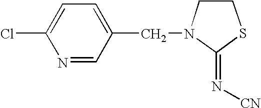

and is known from EP A2 0 235 725.

Dinotefuran has the structure

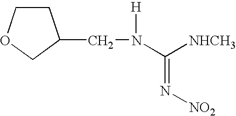

and is known from EP A10 649 845.

Acetamiprid has the structure

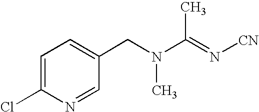

and is known from WO A1 91/04965.

Nitenpyram has the structure

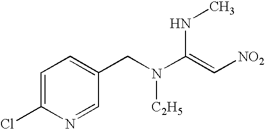

and is known from EP A2 0 302 389.

Imidacloprid has the structure

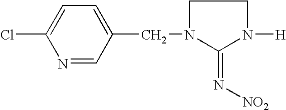

and is known from EP 0 192 060.

The ratio of the active compounds used to each other as well as the total amount of mixture applied is dependent upon the species and occurrence of the insects. The optimal ratios and the total amounts applied for each application can be determined individually in test series.

An especially preferred mixture of the invention contains active compounds ethiprole and imidacloprid. In the mixture the ratio by weight of the two active compounds relative to each other lies preferably between 125 to 1 and 1 to 50 and more preferably between 25 to 1 and 1 to 5, where here and hereinafter ethiprole in the mixture is named first in each case.

A further especially preferred mixture of the invention contains the active compounds ethiprole and acetamiprid. The ratio by weight of the two active compounds in the mixture lies preferably between 125 to 1 and 1 to 50 and more preferably between 25 to 1 and 1 to 5.

A further especially preferred mixture of the invention contains the active compounds ethiprole and nitenpyram. The ratio by weight of the two active compounds in the mixture lies preferably between 125 to 1 and 1 to 50, and more preferably between 25 to 1 and 1 to 5.

A further especially preferred mixture of the invention contains the active compounds ethiprole and dinotefuran. The ratio by weight of the two active compounds in the mixture lies preferably between 125 to 1 and 1 to 50, and more preferably between 25 to 1 and 1 to 5.

A further especially preferred mixture of the invention contains the active compounds ethiprole and thiamethoxam. The ratio by weight of the two active compounds in the mixture lies preferably between 125 to 1 and 1 to 50, and more preferably between 25 to 1 and 1 to 5.

A further especially preferred mixture of the invention contains the active compounds ethiprole and clothianidin. The ratio by weight of the two active compounds in the mixture lies preferably between 125 to 1 and 1 to 50, and more preferably between 25 to 1 and 1 to 5.

A further especially preferred mixture contains of the invention the active compounds ethiprole and thiacloprid. The weight ratio of the two active compounds in the mixture lies preferably between 125 to 1 and 1 to 50, and more preferably between 25 to 1 and 1 to 5.

The combinations of active compounds are with good plant tolerance and favourable haematherm toxicity suitable for the control of animal pests, in particular insects, arachnids and nematodes which occur in farming, forestry, in storage and materials protection as well as in the hygiene sector. They can be mostly used as plant protection agents. They are active against normally sensitive and resistant species and against all or individual development stages. The aforementioned pests include:

From the order Isopoda e.g. Oniscus asellus, Armadillidium vulgare, Porcellio scaber,

From the order Diplopoda e.g. Blaniulus guttulatus,

From the order Chilopoda e.g. Geophilus carpophagus, Scutigera spp.,

From the order Symphyla e.g. Scutigerella immaculata,

From the order Thysanura e.g. Lepisma saccharina,

From the order Collembola e.g. Onychiurus armatus,

From the order Orthoptera e.g. Acheta domesticus, Gryllotalpa spp., Locusta migratoria migratorioides, Melanoplus spp., Schistocerca gregaria,

From the order Blattaria e.g. Blatta orientalis, Periplaneta americana, Leucophaea maderae, Blattella germanica,

From the order Dermaptera e.g. Forficula auricularia,

From the order Isoptera e.g. Reticulitermes spp.,

From the order Phthiraptera e.g. Pediculus humanus corporis, Haematopinus spp., Linognathus spp., Trichodectes spp., Damalinia spp.,

From the order Thysanoptera e.g. Hercinothrips femoralis, Thrips tabaci, Thrips palmi, Frankliniella occidentalis,

From the order Heteroptera e.g. Eurygaster spp., Dysdercus intermedius, Piesma quadrata, Cimex lectularius, Rhodnius prolixus, Triatoma spp.,

From the order Homoptera e.g. Aleurodes brassicae, Bemisia tabaci, Trialeurodes vaporariorum, Aphis gossypii, Brevicoryne brassicae, Cryptomyzus ribis, Aphis fabae, Aphis pomi, Eriosoma lanigerum, Hyalopterus arundinis, Phylloxera vastatrix, Pemphigus spp., Macrosiphum avenae, Myzus spp., Phorodon humuli, Rhopalosiphum padi, Empoasca spp., Euscelis bilobatus, Nephotettix cincticeps, Lecanium corni, Saissetia oleae, Laodelphax striatellus, Nilaparvata lugens, Aonidiella aurantii, Aspidiotus hederae, Pseudococcus spp., Psylla spp.,

From the order Lepidoptera e.g. Pectinophora gossypiella, Bupalus piniarius, Chematobia brumata, Lithocolletis blancardella, Hyponomeuta padella, Plutella xylostella, Malacosoma neustria, Euproctis chrysorrhoea, Lymantria spp., Bucculatrix thurberiella, Phyllocnistis citrella, Agrotis spp., Euxoa spp., Feltia spp., Earias insulana, Heliothis spp., Mamestra brassicae, Panolis flammea, Spodoptera spp., Trichoplusia ni, Carpocapsa pomonella, Pieris spp., Chilo spp., Pyrausta nubilalis, Ephestia kuehniella, Galleria mellonella, Tineola bisselliella, Tinea pellionella, Hofinannophila pseudospretella, Cacoecia podana, Capua reticulana, Choristoneura fumiferana, Clysia ambiguella, Homona magnanima, Tortrix viridana, Cnaphalocerus spp., Oulema oryzae,

From the order Coleoptera e.g. Anobium punctatum, Rhizopertha dominica, Bruchidius obtectus, Acanthoscelides obtectus, Hylotrupes bajulus, Agelastica alni, Leptinotarsa decemlineata, Phaedon cochleariae, Diabrotica spp., Psylliodes chrysocephala, Epilachna varivestis, Atomaria spp., Oryzaephilus surinamensis, Anthonomus spp., Sitophilus spp., Otiorrhynchus sulcatus, Cosmopolites sordidus, Ceuthorrhynchus assimilis, Hypera postica, Dermestes spp., Trogoderma spp., Anthrenus spp., Attagenus spp., Lyctus spp., Meligethes aeneus, Ptinus spp., Niptus hololeucus, Gibbium psylloides, Tribolium spp., Tenebrio molitor, Agriotes spp., Conoderus spp., Melolontha melolontha, Amphimallon solstitialis, Costelytra zealandica, Lissorhoptrus oryzophilus,

From the order Hymenoptera e.g. Diprion spp., Hoplocampa spp., Lasius spp., Monomorium pharaonis, Vespa spp.,

From the order Diptera e.g. Aedes spp., Anopheles spp., Culex spp., Drosophila melanogaster, Musca spp., Fannia spp., Calliphora erythrocephala, Lucilia spp., Chrysomyia spp., Cuterebra spp., Gastrophilus spp., Hyppobosca spp., Stomoxys spp., Oestrus spp., Hypoderma spp., Tabanus spp., Tannia spp., Bibio hortulanus, Oscinella frit, Phorbia spp., Pegomyia hyoscyami, Ceratitis capitata, Dacus oleae, Tipula paludosa, Hylemyia spp., Liriomyza spp.,

From the order Siphonaptera e.g. Xenopsylla cheopis, Ceratophyllus spp.,

From the class Arachnida e.g. Scorpio maurus, Latrodectus mactans, Acarus siro, Argas spp., Ornithodoros spp., Dermanyssus gallinae, Eriophyes ribis, Phyllocoptruta oleivora, Boophilus spp., Rhipicephalus spp., Amblyomma spp., Hyalomma spp., Ixodes spp., Psoroptes spp., Chorioptes spp., Sarcoptes spp., Tarsonemus spp., Bryobia praetiosa, Panonychus spp., Tetranychus spp., Hemitarsonemus spp., Brevipalpus spp.

The plant parasitic nematodes include, for example, Pratylenchus spp., Radopholus similis, Ditylenchus dipsaci, Tylenchulus semipenetrans, Heterodera spp., Globodera spp., Meloidogyne spp., Aphelenchoides spp., Longidorus spp., Xiphinema spp., Trichodorus spp., Bursaphelenchus spp.

According to the invention all plants and plant parts can be treated. By plants is meant all plants and plant populations such as desirable and undesirable wild plants or cultigens (including naturally occurring cultigens). Cultigens can be plants obtained by conventional propagation and optimisation methods or by bioengineering and genetic engineering methods or by combinations of these methods, including transgenic plants and including plant varieties protectable or not protectable by plant varieties protective rights. By plant parts is meant all above ground and below ground parts and organs of plants such as shoot, leaf, blossom and root, whereby for example leaves, needles, stems, branches, blossoms, fruiting bodies, fruits and seed as well as roots, corms and rhizomes are listed. Crops and vegetative and generative propagating material, for example cuttings, corms, rhizomes, runners and seeds also belong to plant parts.

The especially advantageous action of the agents of the invention are emphasised in respect of the application for cereals, for example, wheat, oats, barley, spelt, triticale, and rye, but also maize, millet, rice, sugar cane, soy, sunflower, potatoes, cotton, rape, canola, tobacco, sugar beet, fodder beet, asparagus, hops as well as fruit plants (including rosaceous fruit, for example apples and pears, stone-fruits, for example peaches, nectarines, cherries, plums and apricots, citrus fruit, for example, oranges, grapefruit, limes, lemons, kumquats, mandarins and satsumas, nuts, for example pistachios, almonds, walnuts and pecan nuts, tropical fruits, for example, mango, papaya, pineapple, dates and bananas, and grapes) and vegetables (including leaf vegetables, for example endives, lambs lettuce, fennel, globe and loose-leaf salad, chard, spinach and chicory, brassicas, for example, cauliflower, broccoli, Chinese cabbage, kale (winter kale or curly kale), kohlrabi, brussel sprouts, red cabbage, white cabbage and savoy, fruiting vegetables, for example, aubergines, cucumbers, paprika, marrow, tomatoes, courgettes and sweetcorn, root vegetables, for example celeriac, turnip, carrots, swedes, radishes, horse radish, beetroot, salsify, celery, pulses, for example, peas and beans, and bulb vegetables, for example leeks and onions).

The treatment of plants and plant parts with the active compound combination is according to the invention carried out directly or by action on their environment, habitat or storage area by means of the normal treatment methods, e.g., by dipping, spraying, evaporation, misting, scattering, coating, and with propagation material, especially seeds, also by single or multiple coating.

The mixtures of the invention are particularly suitable for the treatment of seeds. A large part of the damage caused by pests on cultigens occurs by infestation of the seed during storage and after sowing the seed in the ground as well as during and immediately after germination of the plants. This phase is especially critical since the roots and shoots of the growing plant are particularly sensitive and even a small amount of damage can lead to withering of the whole plant. There is therefore considerable interest in protecting the seed and the germinating plant by the use of suitable agents.

The control of pests by treatment of the seeds of plants has been known for a considerable time and is the object of continuous improvement. However, there are a number of problems in the treatment of seed that cannot always be satisfactorily solved. Therefore it is worthwhile to develop methods for the protection of seeds and germinating plants which makes the additional application of plant protection agents after seeding or after germination of the plants superfluous. It is further worthwhile to optimise the amount of the applied active material such that the seed and the germinating plants are protected against infestation by pests as best as possible without the plants themselves being damaged by the active compound applied. In particular, methods for the treatment seed should also take into account the intrinsic insecticidal properties of transgenic plants in order to achieve optimal protection of the seed and germinating plants with a minimal expenditure of plant protection agents.

The present invention relates therefore especially to a method for the protection of seed and germinating plants front infestation with pests in that the seed is treated with an agent of the invention. In addition the invention relates also to the use of the agent of the invention for the treatment seed for protection of the seed and the germinating plants from pests. Furthermore the invention relates to seed which was treated with an agent of the invention for protection from pests.

One of the advantages of the invention is because of the special systemic properties of the agents of the invention treatment with these agents protects not only the seed itself from pests but also the plants emerging after sprouting. In this way the direct treatment of the culture at the time of sowing or shortly thereafter can be omitted.

A further advantage is the synergistic increase in insecticidal activity of the agents of the invention in comparison to the respective individual active compounds, which extends beyond the sum of the activity of both individually applied active compounds. In this way an optimisation of the amount of active compound applied is made possible.

It is also be regarded as advantageous that the mixtures of the invention can also be used in particular with transgenic seeds whereby the plants emerging from this seed are capable of the expression of a protein directed against pests. By treatment of such seed with the agents of the invention certain pests can already be controlled by expression of the, for example, insecticidal protein, and it is additionally surprising that a synergistic activity supplementation occurs with the agents of the invention, which improves still further the effectiveness of the protection from pest infestation.

The agents of the invention are suitable for the protection of seed of plant varieties of all types as already described which are used in agriculture, in greenhouses, in forestry, in garden construction or in vineyards. In particular, this concerns seed of maize, peanut, canola, rape, poppy, olive, coconut, cacao, soy cotton, beet, (e.g. sugar beet and feed beet), rice, millet, wheat, barley, oats, rye, sunflower, sugar cane or tobacco. The agents of the invention are also suitable for the treatment of the seed of fruit plants and vegetables as previously described. Particular importance is attached to the treatment of the seed of maize, soy, cotton, wheat and canola or rape. Thus, for example, the mixtures of the invention including the active compounds methiocarb and imidacloprid are particularly suitable for the treatment of maize seed.

As already described, the treatment of transgenic seed with an agent of the invention is of particular importance. This concerns the seeds of plants which generally contain at least one heterologous gene that controls the expression of a polypeptide with special insecticidal properties. The heterologous gene in transgenic seed can originate from microorganisms such as Bacillus, Rhizobium, Pseudomonas, Serratia, Trichoderma, Clavibacter, Glomus or Gliocladium. The present invention is particularly suitable for the treatment of transgenic seed that contains at least one heterologous gene that originates from Bacillus sp. and whose gene product exhibits activity against the European corn borer and/or western corn rootworm. Particularly preferred is a heterologous gene that originates from Bacillus thuringiensis.

Within the context of the present invention the agent of the invention is applied to the seed alone or in a suitable formulation. Preferably the seed is handled in a state in which it is so stable, that no damage occurs during treatment. In general treatment of the seed can be carried out at any time between harvest and sowing. Normally seed is used that was separated from the plant and has been freed of spadix, husks, stalks, pods, wool or fruit flesh.

In general care must be taken during the treatment of the seed that the amount of the agent of the invention and/or further additive applied to the seed is so chosen that the germination of the seed is not impaired and the emerging plant is not damaged. This is to be noted above all with active compounds which can show phytotoxic effects when applied in certain amounts.

The agents of the invention can be applied directly, that is without containing additional components and without being diluted. It is normally preferred to apply the agent to the seed in the form of a suitable formulation. Suitable formulations and methods for seed treatment are known to the person skilled in the art and are described, for example, in the following documents: U.S. Pat. No. 4,272,417 A, U.S. Pat. No. 4,245,432 A, U.S. Pat. No. 4,808,430 A, U.S. Pat. No. 5,876,739 A, US 2003/0176428 A1, WO 2002/080675 A1, WO 2002/028186 A2.

The active component combinations can be converted into the normal formulations such as solutions, emulsions, spray powders, suspensions, powders, dusting agents, pastes, soluble powders, granulates, suspension-emulsion concentrates, active component-impregnated natural and synthetic materials as well as microencapsulation in polymeric materials.

These formulations are prepared in the usual way, for example by mixing the active components with diluents, that is liquid solvents and/or solid supports, optionally with the use of surfactants, that is emulsifiers, and/or dispersants and/or foaming agents.

In the case of the use of water as diluent organic solvents, for example, can also be used as auxiliary solvents. Suitable liquid solvents are essentially: aromatics such as xylene, toluene or alkylnaphthalines, chlorinated aromatics and chlorinated aliphatic hydrocarbons such as chlorobenzenes, chloroethylenes or methylene chloride, aliphatic hydrocarbons such as cyclohexane or paraffins, e.g. natural oil fractions, mineral and vegetable oils, alcohols such as butanol or glycol and their ethers and esters, ketones such as acetone, methylethylketone, methylisobutylketone or cyclohexanone, strongly polar solvents such as dimethylformamide and dimethylsulphoxide as well as water.

Suitable solid supports are: for example, ammonium salts and natural mineral powders such as kaolin, clays, talc, chalk, quartz, attapulgite, montmorillonite or diatomaceous earth and synthetic mineral powders such as fine particle silica, aluminium oxide and silicates; suitable as solid supports for granulates are: for example crushed and fractionated natural rock such as calcite, marble, pumice, sepiolite, dolomite and synthetic granulates of inorganic and organic flours such as granulates from organic material such as sawdust, coconut shells, maize cobs and tobacco stalks; suitable as emulsifiers and/or foaming agents are: e.g. noniogenic and anionic emulsifiers such as polyethyleneglycol fatty acid esters, polyethyleneglycol fatty alcohol ethers, for example polyethyleneglycol alkylaryl ethers, alkylsulphonates, alkylsulphates, arylsulphonates as well as hydrolysed protein; suitable as dispersants are: for example lignosulphite waste liquor and methylcellulose.

Binding agents such as carboxymethylcellulose, natural and synthetic powdery, granular or latex-like polymers can be used in the formulations, such as gum arabic, polyvinyl alcohol, polyvinyl acetate, as well as natural phospholipids such as cephalins and lecithins and synthetic phospholipids. Further additives can be mineral and vegetable oils.

Colouring agents such as inorganic pigments, for example iron oxide, titanium oxide, ferrocyanblue, and organic pigments such as alizarin, azo and metallophthalocyanine dyes, and trace elements such as iron, manganese, boron, copper, cobalt, molybdenum and zinc salts can be used.

The formulations contain in general between 0.1 and 95% by weight active compound, preferably between 0.5 and 90%.

Optionally the active compound combinations of the invention can be present in normal commercial formulations as well as in application forms prepared from these formulations in admixture with other active compounds such as insecticides, attractants, sterilising agents, bactericides, acaricides, nematocides, fungicides, growth regulators or herbicides. The insecticides include for example phosphoric acid esters, carbamates, carboxylic acid esters, chlorinated hydrocarbons, phenylureas, materials formed by microorganisms, inter alia.

Particularly suitable mixture partners are, for example, the following:

### Fungicides:

aldimorph, ampropylfos, ampropylfos-potassium, andoprim, anilazine, azaconazole, azoxystrobin,
benalaxyl, benodanil, benomyl, benzamacril, benzamacryl-isobutyl, bialaphos, binapacryl, biphenyl, bitertanol, blasticidin-S, bromuconazole, bupirimate, buthiobat,
calcium polysulphide, capsimycin, captafol, captan, carbendazim, carboxin, carvone, chinomethionat (quinomethionat), chlobenthiazone, chlorfenazole, chloroneb, chloropicrin, chlorothalonil, chlozolinate, clozylacon, cufraneb, cymoxanil, cyproconazole, cyprodinil, cyprofuram,
debacarb, dichlorophen, diclobutrazol, diclofluanid, diclomezine, dicloran, diethofencarb, difenoconazole, dimethirimol, dimethomorph, diniconazol, diniconazole-M, dinocap, diphenylamine, dipyrithione, Ditalimfos, dithianon, dodemorph, dodine, drazoxolon,
ediphenphos, epoxiconazole, etaconazole, ethirimol, etridiazole,
famoxadone, fenapanil, fenarimol, fenbuconazole, fenfuram, fenitropan, fenpiclonil, fenpropidin, fenpropimorph, fentin acetate, fentin hydroxyde, ferbam, ferimzone, fluazinam, flumetover, fluoromide, fluquinconazole, flurprimidol, flusilazole, flusulphamide, flutolanil, flutriafol, folpet, fosetyl-aluminium, fosetyl-sodium, phthalide, fuberidazole, furalaxyl, furametpyr, furcarbonil, furconazole, furconazole-cis, furmecyclox,
guazatin,
hexachlorobenzene, hexaconazole, hymexazole,
imazalil, imibenconazole, iminoctadine, iminoctadinealbesilate, iminoctadine triacetate, iodocarb, ipconazole, iprobenfos (IBP), iprodione, irumamycin, isoprothiolane, isovaledione,
kasugamycin, kresoxim-methyl, copper preparations, such as: copper hydroxide, copper naphthenate, copper oxychloride, copper sulphate, copper oxide, oxine-copper and Bordeaux mixture,
mancopper, mancozeb, maneb, meferimzone, mepanipyrim, mepronil, metalaxyl, metconazole, methasulphocarb, methfuroxam, metiram, metomeclam, metsulphovax, mildiomycin, myclobutanil, myclozolin,
nickel dimethyldithiocarbamate, nitrothal-isopropyl, nuarimol,
ofurace, oxadixyl, oxamocarb, oxolinic acid, oxycarboxim, oxyfenthiin,
paclobutrazol, pefurazoate, penconazole, pencycuron, phosdiphen, pimaricin, piperalin, polyoxin, polyoxorim, probenazole, prochloraz, procymidone, propamocarb, propanosine-sodium, propiconazole, propineb, pyrazophos, pyrifenox, pyrimethanil, pyroquilon, pyroxyfur,
quinconazole, quintozene (PCNB),
Sulphur and sulphur preparations,
tebuconazole, tecloftalam, tecnazene, tetcyclacis, tetraconazole, thiabendazole, thicyofen, thifluzamide, thiophanate-methyl, thiram, tioxymid, tolclofos-methyl, tolylfluanid, triadimefon, triadimenol, triazbutil, triazoxide, trichlamide, tricyclazole, tridemorph, triflumizole, triforine, triticonazole,
uniconazole,
validamycin A, vinclozolin, viniconazole,
Zarilamid, Zineb, Ziram as well as

### Dagger G,

### OK-8705,

### OK-8801,

α-(1,1-dimethylethyl)-β-(2-phenoxyethyl)-1H-1,2,4-triazole-1-ethanol,
α-(2,4-dichlorophenyl)-β-fluoro-b-propyl-1H-1,2,4-triazole-1-ethanol,
α-(2,4-dichlorophenyl)-β-methoxy-a-methyl-1H-1,2,4-triazole-1-ethanol,
α-(5-methyl-1,3-dioxan-5-yl)-β-[[4-(trifluoromethyl)-phenyl]-methylene]-1H-1,2,4-triazole-1-ethanol,
(5RS,6RS)-6-hydroxy-2,2,7,7-tetramethyl-5-(1H-1,2,4-triazol-1-yl)-3-octanone,
(E)-a-(methoxyimino)-N-methyl-2-phenoxy-phenylacetamide,
{2-methyl-1-[[[1-(4-methylphenyl)-ethyl]-amino]-carbonyl]-propyl}-carbamate-1-isopropyl ester
1-(2,4-dichlorophenyl)-2-(1H-1,2,4-triazol-1-yl)-ethanone-O-(phenylmethyl)-oxime,
1-(2-methyl-1-naphthalenyl)-1H-pyrrole-2,5-dione,
1-(3,5-dichlorophenyl)-3-(2-propenyl)-2,5-pyrrolidinedione,
1-[(diiodomethyl)-sulphonyl]4-methyl-benzene,
1-[[2-(2,4-dichlorophenyl)-1,3-dioxolan-2-yl]-methyl]-1H-imidazole,
1-[[2-(4-chlorophenyl)-3-phenyloxiranyl]-methyl]-1H-1,2,4-triazole,
1-[1-[2-[(2,4-dichlorophenyl)-methoxy]-phenyl]-ethenyl]-1H-imidazole,
1-methyl-5-nonyl-2-(phenylmethyl)-3-pyrrolidinol,
2′,6′-dibromo-2-methyl-4′-trifluoromethoxy-4′-trifluoro-methyl-1,3-thiazole-5-carboxanilide,
2,2-dichloro-N-[1-(4-chlorophenyl)-ethyl]-1-ethyl-3-methyl-cyclopropanecarboxamide,
2,6-dichloro-5-methylthio)-4-pyrimidinylthiocyanate,
2,6-dichloro-N-(4-trifluoromethylbenzyl)benzamide,
2,6-dichloro-N-[[4-trifluoromethyl)-phenyl]-methyl]benzamide,
2-(2,3,3-triiodo-2-propenyl)-2H-tetrazole,
2-[(1-methylethyl)-sulfonyl]-5-trichloromethyl)-1,3,4-thiadiazole,
2-[[6-deoxy-4-O-4-methyl-β-D-glycopyranosyl)-α-D-glucopyranosyl]-amino]-4-methoxy-1H-pyrrolo[2,3-d]pyrimidine-5-carbonitrile,
2-aminobutane,
2-bromo-2-bromomethyl)pentanedinitrile,
2-chloro-N-(2,3-dihydro-1,1,3-trimethyl-1H-indene-4-yl)-3-pyridine carboxamide,
2-chloro-N-(2,6-dimethylphenyl)-N-(isothiocyanatomethyl)acetamide,
2-phenylphenol (OPP),
3,4-dichloro-1-[4-difluoromethoxy)-phenyl]-1H-pyrrole-2,5-dione,
3,5-dichloro-N-[cyano[(1-methyl-2-propynyl)-oxy]-methyl]benzamide,
3-(1,1-dimethylpropyl-1-oxo)-1H-indene-2-carbonitrile,
3-[2-(4-chlorophenyl)-5-ethoxy-3-isoxazolidinyl]-pyridine,
4-chloro-2-cyan-N,N-dimethyl-5-(4-methylphenyl)-1H-imidazole-1-sulphonamide,
4-methyl-tetrazolo[1,5-a]quinazolin-5(4H)-one,
8-(1,1-dimethylethyl)-N-ethyl-N-propyl-1,4-dioxaspiro[4.5]decane-2-methanamine,
8-hydroxyquinoline sulphate,
9H-xanthene-9-carboxy-2-[(phenylamino)carbonyl]-hydrazide,
bis-(1-methylethyl)-3-methyl-4-[(3-methylbenzoyl)-oxy]-2,5-thiophendicarboxylate,
cis-1-(4-chlorophenyl)-2-(1H-1,2,4-triazol-1-yl)-cycloheptanol,
cis-4-[3-[4-(1,1-dimethylpropyl)-phenyl-2-methylpropyl]-2,6-dimethyl-morpholine hydrochloride,
ethyl [(4-chlorophenyl)-azo]cyanoacetate,
potassium hydrogen carbonate,
methanetetrathiol sodium salt,
methyl 1-(2,3-dihydro-2,2-dimethyl-1H-inden-1-yl)-1H-imidazole-5-carboxylate,
methyl N-(2,6-dimethylphenyl)-N-(5-isoxazolylcarbonyl)-DL-alaninate,
methyl N-(chloroacetyl)-N-2,6-(dimethylphenyl)-DL-alaninate,
N-(2,3-dichloro-4-hydroxyphenyl)-1-methyl-cyclohexanecarboxamide.
N-(2,6-dimethylphenyl)-2-methoxy-N-(tetrahydro-2-oxo-3-furanyl)acetamide,
N-(2,6-dimethylphenyl)-2-methoxy-N-(tetrahydro-2-oxo-3-thienyl)acetamide,
N-(2-chloro-4-nitrophenyl)-4-methyl-3-nitro-benzenesulphonamide,
N-(4-cyclohexylphenyl)-1,4,5,6-tetrahydro-2-pyrimidinamine,
N-(4-hexylphenyl)-1,4,5,6-tetrahydro-2-pyrimidinamine,
N-(5-chloro-2-methylphenyl)-2-methoxy-N-(2-oxo-3-oxazolidinyl)acetamide,
N-(6-methoxy)-3-pyridinyl)-cyclopropanecarboxamide,
N-[2,2,2-trichloro-1-[(chloroacetyl)-amino]-ethyl]benzamide,
N-[3-chloro-4,5-bis-2-propinyloxy)-phenyl]-N′-methoxy-methane imidamide,
N-formyl-N-hydroxy-DL-alanine sodium salt,
O,O-diethyl-[2-dipropylamino)-2-oxoethyl]-ethylphosphoramidothioate,
O-methyl-5-phenyl-phenylpropylphosphoramidothioate,
S-methyl-1,2,3-benzothiadiazole-7-carbothioate,
spiro[2H]-1-menzopyran-2,1′(3′H)-isobenzofuran]-3′-one.

### Bactericides:

bronopol, dichlorophen, nitrapyrin, nickel-dimethyldithiocarbamate, kasugamycin, octhilinone, furoic acid, oxytetracyclin, probenazole, streptomycin, tecloftalam, copper sulphate and other copper preparations.

### Insecticides/Acaricides/Nematicides

1. Acetylcholinesterase (AChE) inhibitors
1.1 Carbamates, for example
alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, xylylcarb

triazamate

1.2 Organophosphates, for example
acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, chlorfenvinphos, demeton-5-methyl, demeton-Smethylsulphone, dialifos, diazinon, dichlofenthion, dichlorvos/DDVP, dicrotophos, dimethoate, dimethylvinphos, dioxabenzofos, disulphoton, EPN, ethion, ethoprophos, etrimfos, famphur, fenamiphos, fenitrothion, fensulphothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulphotep, suiprofos, tebupirimfos, temephos, terbufos, tetrachlorvinphos, thiometon, triazophos, triclorfon, vamidothion
   2. Sodium channel modulators/voltage-dependent sodium channel blockers
   2.1 Pyrethroids, for example
acrinathrin, allethrin (d-cis-trans, d-trans), beta-cyfluthrin, bifenthrin, bioallethrin, bioallethrin-5-cyclopentyl-isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, deltamethrin, empenthrin (1R-isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R-trans isomer), prallethrin, profluthrin, protrifenbute, pyresmethrin, resmethrin, RU 15525, silafluofen, tau-fluvalinate, tefluthrin, terallethrin, tetramethrin (-1R-isomer), tralomethrin, transfluthrin, ZXI 8901, pyrethrins (pyrethrum)

DDT

2.2 Oxadiazines, for example indoxacarb
3. Acetylcholine receptor agonists/antagonists
3.1 Chloronicotinyls, for example
acetamiprid, clothianidin, dinotefuran, imidacloprid, nitenpyram, nithiazine, thiacloprid, thiamethoxam
   3.2 nicotine, bensultap, cartap
   4. Acetylcholine receptor modulators
   4.1 Spinosyns, for example spinosad
   5. GABA-controlled chloride channel antagonists
   5.1 Cyclodiene organochlorines, for example
camphechlor, chlordane, endosulphan, gamma-HCH, HCH, heptachlor, lindane, methoxychlor
   5.2 Fiproles, for example
acetoprole, ethiprole, fipronil, vaniliprole
   6. Chloride channel activators
   6.1 Mectins, for example
avermectin, emamectin, emamectin-benzoate, ivermectin, milbemycin
   7. Juvenile hormone mimetics, for example
diofenolan, epofenonane, fenoxycarb, hydroprene, kinoprene, methoprene, pyriproxifen, triprene
   8. Ecdysone agonists/disruptors
   8.1 Diacylhydrazines, for example
chromafenozide, halofenozide, methoxyfenozide, tebufenozide
   9. Chitin biosysnthesis inhibitors
   9.1 Benzoylureas, for example
bistrifluoron, chlofluazuron, diflubenzuron, fluazuron, flucycloxuron, flufenoxuron, hexaflumuron, lufenuron, novaluron, noviflumuron, penfluoron, teflubenzuron, triflumuron

### 9.2 Buprofezin

### 9.3 Cyromazine

10. Inhibitors of oxidative phosphorylation, ATP disruptors

### 10.1 Diafenthiuron

10.2 Organotins, for example azocyclotin, cyhexatin, fenbutatin oxide
11. Decouplers of oxidative phosphorylation by disruption of H-proton gradients
11.1 Pyrroles, for example chlorfenapyr
11.2 Dinitrophenols, for example binapacryl, dinobuton, dinocap, DNOC
12. Site I electron transport inhibitors
12.1 METI's, for example fenazaquin, fenpyroximate, pyrimidifen, pyridaben, tebufenpyrad, tolfenpyrad

### 12.2 Hydramethylnon

### 12.3 Dicofol

13. Site II electron transport inhibitors
Rotenones
   14. Site III electron transport inhibitors
Acequinocyl, Fluacrypyrim
   15. Microbial disruptors of the insect intestinal membrane
Bacillus thuringiensis strains
   16. Inhibitors of fat synthesis
Tetronic acids, for example
   spirodiclofen, spiromesifen
Tetramic acids, for example
   3-(2,5-dimethylphenyl)-8-methoxy-2-oxo-1-azaspiro[4.5]dec-3-en-4-yl ethyl carbonate (alias: carbonic acid, 3-(2,5-dimethylphenyl)-8-methoxy-2-oxo-1-azaspiro[4.5]dec-3-en-4-yl ethyl ester, CAS Reg. No.: 382608-10-8) and carbonic acid, cis-3-(2,5-dimethylphenyl)-8-methoxy-2-oxo-1-azaspiro[4.5]dec-3-en-4-yl ethyl ester (CAS Reg. No.: 203313-25-1)
      17. Carboxamides, for example flonicamid
      18. Octopaminergic agonists, for example amitraz
      19. Inhibitors of magnesium-stimulated ATPase, for example Propargite
      20. BDCAs, for example N-2-[1,1-dimethyl-2-(methylsulphonyl)ethyl]-3-iodo-N1-[2-methyl-4-[1,2,2,2-tetrafluoro-1-(trifluoromethyl)ethyl]phenyl]-1,2-benzenedicarboxamide (CAS Reg. No.: 272451-65-7)
      21. Nereistoxin analogous, for example Thiocyclam hydrogen oxalate, Thiosultap-sodium
      22. Biologics, hormones or pheromones, for example
Azadirachtin, Bacillus spec., Beauveria spec., Codlemone, Metarrhizium spec., Paecilomyces spec., Thuringiensin, Verticillium spec.
   23. Active compounds with unknown or non-specific mechanisms of action
   23.1 Fumigants, for example
aluminium phosphide, methyl bromide, sulphuryl fluoride
   23.2 Selective feeding inhibitor, for example
Cryolite, Flonicamid, Pymetrozine
   23.3 Mite growth inhibitors, for example
Clofentezine, Etoxazole, Hexythiazox
   23.4 amidoflumet, benclothiaz, benzoximate, bifenazate, bromopropylate, buprofezin, chinomethionat, chlordimeform, chlorobenzilate, chloropicrin, clothiazoben, cycloprene, dicyclanil, fenoxacrim, fentrifanil, flubenzimine, flufenerim, flutenzin, gossyplure, hydramethylnone, japonilure, metoxadiazone, petroleum, piperonyl butoxide, potassium oleate, pyridalyl, sulphluramid, tetradifon, tetrasul, triarathene, verbutin,
   in addition
(1R-cis)-[5-(phenylmethyl)-3-furanyl]-methyl-3-[(dihydro-2-oxo-3(2H)-furanyliden)-methyl]-2,2-dimethylcyclopropane carboxylate
(3-phenoxyphenyl)-methyl-2,2,3,3-tetramethylcyclopropane carboxylate
1-[(2-chloro-5-thiazolyl)methyl]tetrahydro-3,5-dimethyl-N-nitro-1,3,5-triazine-2(1H)-imine
2-(2-chloro-6-fluorophenyl)-4-[4-(1,1-dimethylethyl)phenyl]4,5-dihydrooxazole
2-(acetyloxy)-3-dodecyl-1,4-naphthalindione

### 2-chloro-N-[[[4-(1-phenylethoxy)-phenyl]-amino]-carbonyl]benzamide

2-chloro-N-[[[4-(2,2-dichloro-1,1-difluoroethoxy)-phenyl]-amino]-carbonyl]benzamide
3-methylphenyl-propylcarbamate
4-[4-(4-ethoxyphenyl)-4-methylpentyl]-1-fluoro-2-phenoxybenzene
4-chloro-2-(1,1-dimethylethyl)-5-[[2-(2,6-dimethyl-4-phenoxyphenoxy)ethyl]thio]-3(2H)pyridazinone
4-chloro-2-(2-chloro-2-methylpropyl)-5-[(6-iodo-3-pyridinyl)methoxy]-3(2H)-pyridazinone
4-chloro-5-[(6-chloro-3-pyridinyl)methoxy]-2-(3,4-dichlorophenyl)-3(2H)-pyridazinone
   Bacillus thuringiensis Strain EG-2348
Benzoic acid [2-benzoyl-1-(1,1-dimethylethyl)hydrazide
2,2-dimethyl-3-(2,4-dichlorophenyl)-2-oxo-1-oxaspiro[4.5]dec-3-en-4-yl butanoate
[3-[(6-chloro-3-pyridinyl)methyl]-2-thiazolidinyliden]cyanamide
dihydro-2-(nitromethylen)-2H-1,3-thiazine-3(4H)carboxaldehyde
ethyl-[2-[[1,6-dihydro-6-oxo-1-(phenylmethyl)-4-pyridazinyl]oxy]ethyl]carbamate
N-(3,4,4-trifluoro-1-oxo-3-butenyl)glycine
N-(4-chlorophenyl)-3-[4-(difluoromethoxy)phenyl]-4,5-dihydro-4-phenyl-1H-pyrazol-1-carboxamide
N-methyl-N′-(1-methyl-2-propenyl)-1,2-hydrazindicarbothioamide
N-methyl-N′-2-propenyl-1,2-hydrazindicarbothioamide
O,O-diethyl-[2-(dipropylamino)-2-oxoethyl]-ethylphosphoramidothioate

A mixture with other known active compounds such as herbicides, or with fertilisers and growth regulators is also possible.

During use as insecticides the active compound combinations of the invention can further be present in their normal commercial formulations as well in application forms prepared from these formulations in admixture with synergists. Synergists are compounds through which the action of the active compounds is increased without the added synergist itself having to be active.

The active compound content of the application form prepared from the normal commercial formulation can vary over a wide range. The active compound concentration in the application form can be from 0.0000001 to 95% by weight active compound, preferably between 0.0001 to 1% by weight.

The application is carried out in a normal manner compatible with the form of application.

During use against hygiene and storage pests the active component combinations are characterised by an excellent residual action on wood and clay as well as a good alkali stability on limed supports.

The active compound combinations of the invention act not only against plant, hygiene and storage pests but also in the veterinary medicine sector against animal parasites (ectoparasites) such as hard ticks, soft ticks, mange mites, trombiculid mites, flies (stinging and licking) parasitising fly larvae, lice, biting (chewing) lice and fleas. These parasites include:

From the order Anoplurida e.g. Haematopinus spp., Linognathus spp., Pediculus spp., Phtirus spp., Solenopotes spp.,

From the order Mallophagida and the suborders Amblycerina and Ischnocerina e.g. Trimenopon spp., Menopon spp., Trinoton spp., Bovicola spp., Werneckiella spp., Lepikentron spp., Damalina spp., Trichodectes spp., Felicola spp.,

From the order Diptera and the suborders Nematocerina and Brachycerina e.g. Aedes spp., Anopheles spp., Culex spp., Simulium spp., Eusimulium spp., Phlebotomus spp., Lutzomyia spp., Culicoides spp., Chrysops spp., Hybomitra spp., Atylotus spp., Tabanus spp., Haematopota spp., Philipomyia spp., Braula spp., Musca spp., Hydrotaea spp., Stomoxys spp., Haematobia spp., Morellia spp., Fannia spp., Glossina spp., Calliphora spp., Lucilia spp., Chrysomyia spp., Wohlfahrtia spp., Sarcophaga spp., Oestrus spp., Hypoderma spp., Gasterophilus spp., Hippobosca spp., Lipoptena spp., Melophagus spp.,

From the order Siphonapterida e.g. Pulex spp., Ctenocephalides spp., Xenopsylla spp., Ceratophyllus spp.,

From the order Heteropterida e.g. Cimex spp., Triatoma spp., Rhodnius spp., Panstrongylus spp.,

From the order Blattarida e.g. Blatta orientalis, Periplaneta americana, Blattela germanica, Supella spp.,

From the subclass Acari (Acarina) and the orders of the meta- and mesostigmata e.g. Argas spp., Ornithodorus spp., Otobius spp., Ixodes spp., Amblyomma spp., Boophilus spp., Dermacentor spp., Haemophysalis spp., Hyalomma spp., Rhipicephalus spp., Dermanyssus spp., Raillietia spp., Pneumonyssus spp., Sternostoma spp., Varroa spp.,

From the order Actinedida (Prostigmata) and Acaridida (Astigmata) e.g. Acarapis spp., Cheyletiella spp., Ornithocheyletia spp., Myobia spp., Psorergates spp., Demodex spp., Trombicula spp., Listrophorus spp., Acarus spp., Tyrophagus spp., Caloglyphus spp., Hypodectes spp., Pterolichus spp., Psoroptes spp., Chorioptes spp., Otodectes spp., Sarcoptes spp., Notoedres spp., Knemidocoptes spp., Cytodites spp., Laminosioptes spp.,

The active compound mixtures of the invention are also suitable for the control of arthropods that attack agricultural animals such as cattle, sheep, goats, horses, pigs, donkeys, camels, buffalos, rabbits, chickens, turkeys, ducks, geese, bees, and other domestic animals such as dogs, cats, cage birds, aquarium fish as well as so-called experimental animals such as hamsters, guinea pigs, rats and mice. By controlling these arthropods cases of death and falls in yield (in meat, milk, wool, skins, eggs, honey, etc.) should be reduced so that through the use of the active compound mixtures of the invention more economic and simpler animal husbandry is possible.

The use of the active compound mixtures in the veterinary sector is carried out in a known manner by enteral administration in the form of, for example, tablets, capsules, soaking, drenching, granulates, pastes, boli, the feed-through method, suppositories, by parenteral administration, for example by injection (intramuscular, subcutaneous, intravenous, intraperitoneal, i.a.), implants, by nasal administration, by dermal application in the form of, for example, immersion or dipping or bathing, spraying, pouring (pour-on and spot-on), washing, powdering, as well as with the aid of appliances containing active compounds such as neck collars, ear tags, tail tags, limb bands, halters, marking devices, etc.

In the use for cattle, poultry, domestic animals, etc. the active compounds can be used as formulations (for example powders, emulsions, free-flowing agents) which contain the active compounds in an amount of 1 to 80% by weight, either directly or after 100 to 10,000 times dilution or used as a chemical bath.

It was also found that the active compound combinations of the invention show high insecticidal activity against insects that destroy technical materials.

The following insects are named as example and preferably—but not limited to:

beetles such as

Hylotrupes bajulus, Chlorophorus pilosis, Anobium punctatum, Xestobium rufovillosum, Ptilinus pecticomis, Dendrobium pertinex, Emobius mollis, Priobium carpini, Lyctus brunneus, Lyctus africanus, Lyctus planicollis, Lyctus linearis, Lyctus pubescens, Trogoxylon aequale, Minthes rugicollis, Xyleborus spec., Tryptodendron spec., Apate monachus, Bostrychus capucins, Heterobostrychus brunneus, Sinoxylon spec., Dinoderus minutus,

Hymenoptera such as

Sirex juvencus, Urocerus gigas, Urocerus gigas taignus, Urocerus augur,

termites such as

Kalotermes flavicollis, Cryptotermes brevis, Heterotermes indicola, Reticulitermes flavipes, Reticulitermes santonensis, Reticulitermes lucifugus, Mastotermes darwiniensis, Zootermopsis nevadensis, Coptotermes formosanus,

bristletails such as Lepisma saccharina.

In the present context technical materials are understood to be non-living materials such as preferably plastics, adhesives, glues, paper and cardboard, leather, wood, woodworking products and paints.

Most preferably the materials to be protected against insect infestation are wood and wood fabrication products.

By wood and woodworking products which can be protected by the agents of the invention or mixtures containing them is understood, for example:

timber, wooden beams, railway sleepers, bridge parts, boat landing stages, wooden vehicles, boxes, pallets, containers, telephone masts, wooden coverings, wooden windows and doors, plywood, chipboard, carpentry products or wood products that are quite commonly used in building construction or building carpentry.

The active compound combinations can be applied as such, in the form of concentrates or generally used formulations such as powders, granulates, solutions, suspensions, emulsions or pastes.

The described formulations can be prepared by generally known methods, for example by mixing the active compounds with at least one solvent or diluent, emulsifier, dispersant and/or binding agent or fixative, water-repellents, optionally siccatives and UV stabilisers and optionally colours and pigments as well as other processing auxiliaries.

The insecticidal agents or concentrates used for the protection of wood or woodwork contain the active compound of the invention in a concentration of 0.0001 to 95% by weight, in particular 0.001 to 60% by weight.

The amount of agents or concentrates used depends upon the type and occurrence of the insects and upon the medium. The optimal amount applied can be determined individually by test series. In general, however, it is sufficient to use 0.0001 to 20% by weight, preferably 0.001 to 10% by weight of the active compound relative to the material to be protected.

An organic solvent or solvent mixture and/or an oily or oil-like, low-volatility organic solvent or solvent mixture and/or a polar organic solvent or solvent mixture and/or water and optionally an emulsifier and/or wetting agent can serve as solvent and/or diluent.

Preferably oily or oil-like solvents with an evaporation number above 35 and a flash point above 30° C., preferably above 45° C., are used as organic solvents. Used as such low-volatility, non-water-soluble oily and oil-like solvents are appropriate mineral oils or their aromatic fractions or mineral oil-containing solvent mixtures, preferably white spirit, petroleum and or alkylbenzene.

Advantageously used are mineral oils with a boiling range of 170 to 220° C., white spirit with a boiling range of 170 to 220° C., spindle oil with a boiling range of 250 to 350° C., petroleum or aromatics with a boiling range of 160 to 280° C., turpentine and similar.

In a preferred embodiment liquid aliphatic hydrocarbons with a boiling range of 180 to 210° C. or high boiling mixtures of aromatic and aliphatic hydrocarbons of 180 to 220° C. and/or spindle oil and/or monochloronaphthaline, preferably α-monochloronaphthaline, are used

The organic, low-volatility oily or oil-like solvents with a evaporation number above 35° C. and a flash point above 30° C., preferably above 45° C., can be replaced in part by volatile or medium-volatile organic solvents provided that the solvent mixture also has an evaporation number above 35° C. and a flash point above 30° C., preferably above 45° C., and the insecticide-fungicide mixture is soluble or emulsifiable in this solvent mixture.

According to a preferred embodiment a part of the organic solvent or solvent mixture is replaced by a polar aliphatic organic solvent or solvent mixture. Preferably aliphatic organic solvents containing hydroxyl and/or ester and/or ether groups, such as glycol ethers, esters or similar, are used.

Within the context of the present invention known synthetic resins and/or binding drying oils, especially binding agents consisting of or containing an acrylate resin, a vinyl resin, for example polyvinyl acetate, polyester resin, polycondensation or polyaddition resin, polyurethane resin, alkyd resin or modified alkyd resin, phenolic resin, hydrocarbon resin such as coal tar resin, silicon resin, drying vegetable and/or drying oils and/or physically drying binding agents based on natural and/or artificial resins that are water-dilutable and/or soluble or dispersible or emulsifiable in the organic solvents employed are used.

The artificial resin used as binding agent can be used in the form of an emulsion, dispersion or solution. Bitumen or bituminous substances can be used up to 10% by weight as binding agent. In addition known colorants, pigments, water repellents, odour correctives and inhibitors or corrosion protectants and similar can be used.

According to the invention at least one alkyd resin or modified alkyd resin and/or a drying vegetable oil is preferably present as binding agent in the agent or concentrate. Preferred according to the invention are alkyd resins with an oil content of more than 45% by weight, preferably 50 to 68% by weight.

The binding agent described can be replaced wholly or in part by a fixative (mixture) or a plasticizer (mixture). These additives should prevent evaporation of the active compounds as well as crystallisation or precipitation. Preferably they replace 0.01 to 30% of the binding agent (relative to 100% of the binding agent used).

The plasticizers come from the chemical class of phthalic acid esters such as dibutyl, dioctyl or benzylbutylphthalate, phosphoric acid esters such as tribuitylphosphate, adipic acid esters such as di-(2-ethylhexyl) adipate, stearates such as butyl stearate or amyl stearate, oleates such as butyl oleate, glycerol ethers or higher molecular weight glycol ethers, glycerol esters and ptoluenesulphonic acid esters.

Fixatives are based chemically on polyvinyl allyl ethers, for example polyvinyl methyl ether or ketones such as benzophenone, ethylenebenzophenone.

Water is also particularly suitable as a solvent or diluent, optionally in admixture with one or more of the aforementioned organic solvents or diluents, emulsifiers and dispersants.

A particularly effective wood protection is achieved by industrial-scale impregnation techniques, for example vacuum, double vacuum or pressure methods.

The ready-to-use agents can optionally contain further insecticides and optionally one or more fungicides.

At the same time the active compound combinations of the invention can be used for the protection from the fouling of objects, especially ships' hulls, sieves, nets, buildings, quay facilities and signal equipment which come into contact with sea or brackish water.

Fouling by sessile oligochaetes such as tube worms and by molluscs and species of the group Ledamorpha (goose barnacles), such as different Lepas and Scalpellum species, or by species of the group Balanomorpha (acorn or rock barnacle), such as Balanus or Pollicipes species, increases the frictional resistance of ships and leads to significant increase in operating costs through increased energy consumption and furthermore through frequent dry docking.

In addition to fouling by algae, for example Ectocarpus sp. and Ceramium sp., the fouling by sessile Entomostraca groups which are collected together under the name Cirripedia (barnacles) is of special importance.

It was now surprisingly found that the active compound combinations of the invention exhibit an exceptional antifouling action.

By use of the active component combination of the invention the use of heavy metals as in, for example, bistrialkyltin sulphides, tri-n-butyltin laurate, tri-n-butyltin chloride, copper(I) oxide, triethyltin chloride, tri-n-butyl(2-phenyl-4-chlorophenoxy)-tin, tributyltin oxide, molybdenum disulphide, antimony oxide, polymeric butyltitanate, phenyl(bispyridine)bismuth chloride, tri-n-butyltin fluoride, manganese ethylenebisthiocarbamate, zinc dimethyldithiocarbamate, zinc ethylenebisthiocarbamate, zinc and copper salts of 2-pyridinethiol-1-oxide, bisdimethyldithiocarbamoylzinc ethylenebisthiocarbamate, zinc oxide, copper(I) ethylenebisdithiocarbamate, copper thiocyanate, copper naphthenate and tributyltin halides can be omitted or the concentration of these compounds decisively reduced.

The ready-for-use antifouling paints can optionally contain further active compounds, preferably algicides, fungicides, herbicides, molluscicides or other active antifouling compounds.

Preferentially suitable as combination partners for the antifouling agents of the invention are:

algicides such as
2-tert.-butylamino-4-cyclopropylamino-6-methylthio-1,3,5-triazine, dichlorophen, diuron, endothal, fentin acetate, isoproturon, methabenzthiazuron, oxyfluorfen, quinoclamine and terbutryn;
fungicides such as
benzo[b]thiophen carboxy cyclohexylamide-S,S-dioxide, dichlofluanid, fluorfolpet, 3-iodo-2-propinyl-butylcarbamate, tolylfluanid and azoles such as azaconazole, cyproconazole, epoxyconazole, hexaconazole, metconazole, propiconazole and tebuconazole;
molluscicides such as
Fe sequestrants, fentine acetate, metaldehyd, methiocarb, niclosamid, ethiprole and trimethacarb;
or conventional antifouling compounds such as
4,5-dichloro-2-octyl-4-isothiazolin-3-one, diiodomethylparatrylsulphone, 2-(N,N-dimethylthiocarbamoylthio)-5-nitrothiazyl, potassium, copper, sodium and zinc salts of 2-pyridinethiol-1-oxide, pyridine-triphenylborane, tetrabutyldistannoxane, 2,3,5,6-tetrachloro-4-(methylsulphonyl)-pyridine, 2,4,5,6-tetrachloroisophthalonitrile, tetramethylthiuramdisulphide and 2,4,6-trichlorophenylmaleinimide.

The antifouling agents used contain the active compound in a concentration of 0.001 to 50% by weight, in particular 0.01 to 20% by weight.

Furthermore the antifouling agents contain the conventional components as described in, for example, Ungerer, Chem. Ind. 1985, 37, 730-732 and Williams, Antifouling Marine Coatings, Noyes, Park Ridge, 1973.

In addition to the active algicidal, fungicidal, molluscicidal and insecticidal compounds the antifouling coatings contain in particular binding agents.

Examples of recognised binding agents are polyvinyl chloride in a solvent system, chlorinated rubber in a solvent system, acrylic resins in a solvent system, in particular an aqueous system, vinyl chloride/vinyl acetate copolymer systems in the form of aqueous dispersions or in the form of organic solvent systems, butadiene/styrene/acrylonitrile rubbers, drying oils such as linseed oil, resin esters or modified hard resins in combination with tar or bitumens, asphalt and epoxy compounds, small amounts of chlorinated rubber, chlorinated polypropylene and vinyl resins.

Optionally coating agents also contain inorganic pigments, organic pigments or colorants which are preferably insoluble in sea water. In addition the coating agent can contain materials such as colophonium in order to allow a controlled release of the active compound. The coatings can also contain plasticizers, modifiers affecting rheological properties as well as other conventional components. The active component combinations of the invention can also be incorporated into self-polishing antifouling systems.

The active compound combinations of the invention are also suitable for the control of animal pests, in particular insects, arachnids and mites which occur in enclosed spaces, for example houses, factory halls, offices, vehicle cabins i.a. They can be used alone or in combination with other active compounds and auxiliaries in household insecticide products for the control of these pests. They are effective against sensitive and resistant species and against all development stages.

Such pest include:

From the order Scorpionidea e.g. Buthus occitanus,

From the order Acarina e.g. Argas persicus, Argas reflexus, Bryobia ssp., Dermanyssus gallinae, Glyciphagus domesticus, Ornithodorus moubat, Rhipicephalus sanguineus, Trombicula alfreddugesi, Neutrombicula autumnalis, Dermatophagoides pteronissimus, Dermatophagoides forinae,

From the order Araneae e.g. Aviculariidae, Araneidae,

From the order Opiliones e.g. Pseudoscorpiones chelifer, Pseudoscorpiones cheiridium, Opiliones phalangium,

From the order Isopoda e.g. Oniscus asellus, Porcellio scaber,

From the order of the Diplopoda e.g. Blaniulus guttulatus, Polydesmus spp.

From the order Chilopoda e.g. Geophilus spp.,

From the order Zygentoma e.g. Ctenolepisma spp., Lepisma saccharina, Lepismodes inquilinus,

From the order Blattaria e.g. Blatta orientalies, Blattella germanica, Blattella asahinai, Leucophaea maderae, Panchlora spp., Parcoblatta spp., Periplaneta australasiae, Periplaneta americana, Periplaneta brunnea, Periplaneta fuliginosa, Supella longipalpa,

From the order Saltatoria e.g. Acheta domesticus,

From the order Dermaptera e.g. Forficula auricularia,

From the order Isoptera e.g. Kalotermes spp., Reticulitermes spp.,

From the order Psocoptera e.g. Lepinatus spp., Liposcelis spp.,

From the order Coleptera e.g. Anthrenus spp., Attagenus spp., Dermestes spp., Latheticus oryzae, Necrobia spp., Ptinus spp., Rhizopertha dominica, Sitophilus granarius, Sitophilus oryzae, Sitophilus zeamais, Stegobium paniceum,

From the order Diptera e.g. Aedes aegypti, Aedes albopictus, Aedes taeniorhynchus, Anopheles spp., Calliphora erythrocephala, Chrysozona pluvialis, Culex quinquefasciatus, Culex pipiens, Culex tarsalis, Drosophila spp., Fannia canicularis, Musca domestica, Phlebotomus spp., Sarcophaga carnaria, Simulium spp., Stomoxys calcitrans, Tipula paludosa,

From the order Lepidoptera e.g. Achroia grisella, Galleria mellonelia, Plodia interpunctella, Tinea cloacella, Tinea pellionella, Tineola bisselliella,

From the order Siphonaptera e.g. Ctenocephalides canis, Ctenocephalides felis, Pulex irritans, Tunga penetrans, Xenopsylla cheopis,

From the order Hymenoptera e.g. Camponotus herculeanus, Lasius fuliginosus, Lasius niger, Lasius umbratus, Monomorium pharaonis, Paravespula spp., Tetramorium caespitum,

From the order Anoplura e.g. Pediculus humanus capitis, Pediculus humanus corporis, Phthirus pubis,

From the order Heteroptera e.g. Cimex hemipterus, Cimex lectularius, Rhodinus prolixus, Triatoma infestans,

The use in the sector of household insecticides can also take place in combination with other suitable active compounds such as esters of phosphoric acid, carbamates, pyrethroids, growth regulators or active compounds from other known insecticide classes.

Application carried out with aerosols, non-pressurised sprays, e.g. pumps and nebulisers, automatic misters, foggers, foams, gels, evaporation products with evaporator plates of cellulose or plastic, liquid evaporators, gel and membrane evaporators, propeller-driven evaporators, non-energy or passive evaporator systems, moth paper, moth bags and moth gels as granulate or dusts, in scatter bait or bait stations.

During use of the active compound combinations of the invention the amount applied can be varied within a wide range depending on the method of application. In the treatment of plant parts the amount of active compound combination used lies generally between 0.1 and 10,000 g/ha, preferably between 10 and 1,000 g/ha.

The good insecticidal action of the active compound combinations of the invention is seen from the following examples. Whereas the individual active compound show weaknesses in their action, the combinations exhibit an action which extends beyond a simple summation of action.

The action expected for a given combination of two active components can be calculated as follows (cf. Colby, S. R., “Calculating Synergistic and Antagonistic Responses of Herbicide Combinations”, Weeds 15, pages 20-22, 1967):

if
X stands for the death rate expressed as % of the untreated controls on application of active component A at an applied amount of m ppm
Y for the death rate expressed as % of the untreated controls on application of active component B at an applied amount of n ppm
E for the death rate expressed as % of the untreated controls on application of active components A and B at applied amount of m and n ppm
   then

$$E = X + Y - \frac{X \times Y}{100}$$

If the actual insecticidal death rate is greater than calculated, the combination is superadditive in its death rate, i.e. there is a synergistic effect. In this case the death rate actually observed must be greater than the value for the expected death rate (E) calculated from the above equation.

### EXAMPLE A

### Nilaparvata lugens Test (Field)

| | |
|---|---|
| Products (standard formulation): | imidacloprid EC 050 |
| | ethiprole SC 100 |

To prepare a suitable formulation of the active material the desired amount of product is mixed with an appropriate amount of water and diluted to the desired concentration.

Rice plants (Oryza sativa) are sprayed with the desired product concentration and infested with the brown rice plant hopper (Nilaparvata lugens).

After the desired time the number of living plant hoppers is determined and the death rate calculated in %, where 100% means that all plant-hoppers were killed, 0% that no plant hoppers were killed.

In this test the following active compound combination of the present application showed a synergistically increase in activity in comparison to the active compounds applied individually:

TABLE A
Plant damaging insects
Nilaparvata lugens test (field trial)

| | Concentration | Death rate |
|---|---|---|
| Product | in g ai/ha | in % after 21^{d} |
| Imidacloprid EC 050 | 12.5 | 0 |
| Ethiprole SC 100 | 12.5 | 3.1 |

Imidacloprid EC 050 + ethiprole SC 100 (1:1)

| | | | |
|---|---|---|---|
| | | obs* | calc.** |
| as per the invention | 12.5 + 12.5 | 90.8 | 3.1 |

*obs. = observed activity
**calc. = activity calculated by the Colby equation

### EXAMPLE B

### Myzus persicae Test

| | |
|---|---|
| Solvent: | 7 parts by weight dimethylformamide |
| Emulsifier: | 2 parts by weight alkylarylpolyglycolether |

To prepare a suitable formulation of the active material 1 part by weight of the active material is mixed with the given amounts of solvent and emulsifier and the concentrate is diluted to the desired concentration with water containing the emulsifier.

Cabbage leaves (Brassica oleracea) which are highly infected by the green peach aphid (Myzus persicae) are treated by dipping into the active mixture formulation of the desired concentration.

After the desired time the death rate is calculated as %, where 100% means that all aphids were killed, 0% that no aphids were killed. The death rates were calculated by the Colby equation.

In this test, for example, the following active compound combination of the present application shows a synergistic increase in activity in comparison to the active compounds applied individually.

TABLE B
Plant damaging insects
Myzus pericae test

| | Concentration | Death rate |
|---|---|---|
| Active compound | in ppm | in % after 6^{d} |
| Ethiprole | 4 | 0 |
| Clothianidin | 4 | 0 |

Ethiprole + clothianidin (1:1)

| | | | |
|---|---|---|---|
| | | obs.* | calc.** |
| as per the invention | 4 + 4 | 20 | 0 |

*obs. = observed activity
**calc. = activity calculated by the Colby equation.

TABLE B
Plant damaging insects
Myzus pericae test

| | Concentration | Death rate |
|---|---|---|
| Active compound | in ppm | in % after 6^{d} |
| Ethiprole | 0.8 | 0 |
| Imidacloprid | 0.16 | 0 |

Ethiprole + imidacloprid (5:1)

| | | | |
|---|---|---|---|
| | | obs.* | calc.** |
| as per the invention | 0.8 + 0.16 | 70 | 0 |

*obs. = observed activity
**calc. = activity calculated by the Colby equation.

TABLE B
Plant damaging insects
Myzus pericae test

| | Concentration | Death rate |
|---|---|---|
| Active compound | in ppm | in % after 6^{d} |
| Ethiprole | 4 | 10 |
| Thiacloprid | 0.8 | 15 |

Ethiprole + thiacloprid (5:1)

| | | | |
|---|---|---|---|
| | | obs.* | calc.** |
| as per the invention | 4 + 0.8 | 45 | 23.5 |

*obs. = observed activity
**calc. = activity calculated by the Colby equation.

### EXAMPLE C

### Plutella xylostella Test (Normal Sensitive Strain)

| | |
|---|---|
| Solvent: | 7 parts by weight dimethylformamide |
| Emulsifier: | 2 parts by weight alkylarylpolyglycolether |

To prepare a suitable formulation of the active material 1 part by weight of the active material is mixed with the given amounts of solvent and emulsifier and the concentrate is diluted to the desired concentration with water containing the emulsifier.

Cabbage leaves (Brassica oleracea) are treated by dipping into the active mixture formulation at the desired concentration and infected with the caterpillar of the diamondback (cabbage) moth (Plutella xylostella, normal sensitive strain) while the leaves are still moist.

After the desired time the death rate is calculated as %, where 100% means that all caterpillars were killed, 0% that no caterpillars were killed. The death rates are calculated by the Colby equation.

In this test, for example, the following active compound combination of the present application shows a synergistic increase in activity in comparison to the active compounds applied individually.

TABLE C
Plant damaging insects
Plutella xylostella (normal sensitive strain) test

| | Concentration | Death rate |
|---|---|---|
| Active compound | in ppm | in % after 6^{d} |
| Ethiprole | 4 | 0 |
| Clothianidin | 4 | 10 |

Ethiprole + clothianidin (1:1)

| | | | |
|---|---|---|---|
| | | obs.* | calc.** |
| as per the invention | 4 + 4 | 75 | 10 |

*obs. = observed activity
**calc. = activity calculated by the Colby equation.

TABLE C
Plant damaging insects
Plutella xylostella (normal sensitive strain) test

| | Concentration | Death rate |
|---|---|---|
| Active compound | in ppm | in % after 4^{d} |
| Ethiprole | 20 | 35 |
| Thiacloprid | 4 | 0 |

Ethiprole + thiacloprid (5:1)

| | | | |
|---|---|---|---|
| | | obs.* | calc.** |
| as per the invention | 20 + 4 | 55 | 35 |

*obs. = activity observed
**calc. = activity calculated by the Colby equation.

### EXAMPLE D

### Spodoptera frugiperda Test

| | |
|---|---|
| Solvent: | 7 parts by weight dimethylformamide |
| Emulsifier: | 2 parts by weight alkylarylpolyglycolether |

To prepare a suitable formulation of the active material 1 part by weight of the active material is mixed with the given amounts of solvent and emulsifier and the concentrate is diluted to the desired concentration with water containing the emulsifier.

Cabbage leaves (Brassica oleracea) are treated by dipping in the active mixture formulation at the desired concentration and infected with the caterpillar of the army worm (Spodoptera frugiperda) while the leaves are still moist.

After the desired time the death rate is calculated as %, where 100% means that all caterpillars were killed, 0% that no caterpillars were killed. The death rates are calculated by the Colby equation.

In this test, for example the following active compound combination of the present application shows a synergistic increase in activity in comparison to the active compounds applied individually.

TABLE D
Plant damaging insects
Spodoptera frugiperda test

| | Concentration | Death rate |
|---|---|---|
| Active compound | in ppm | in % after 6^{d} |
| Ethiprole | 4 | 0 |
| Imidacloprid | 4 | 15 |

Ethiprole + imidacloprid (1:1)

| | | | |
|---|---|---|---|
| | | obs.* | calc.** |
| as per the invention | 4 + 4 | 40 | 15 |

*obs. = observed activity
**calc. = activity calculated by the Colby equation.

1. Agent containing a synergistically active mixture of ethiprole of structure 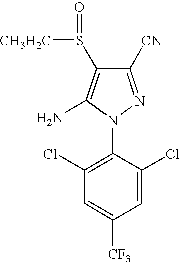
and at least one compound from the series of the neonicotinoids.

2. The agent of claim 1, containing a synergistically active mixture of ethiprole and imidacloprid.

3. The agent of claim 1, containing a synergistically active mixture of ethiprole and aetamiprid.

4. The agent of claim 1, containing a synergistically active mixture of ethiprole and nitenpyram.

5. The agent of claim 1, containing a synergistically active mixture of ethiprole and thiamethoxam.

6. The agent of claim 1, containing a synergistically active mixture of ethiprole and clothianidin.

7. The agent of claim 1, containing a synergistically active mixture of ethiprole and thiacloprid.

8. The agent of claim 1, containing a synergistically active mixture of ethiprole and dinotefuran.

9. (canceled)

10. Method for the preparation of pest control agents characterised in that a synergistically active mixture as described in one of the claims 1 to 8 is mixed with diluents and/or surfactants.

11. Method for controlling animal pests comprising: administering or contacting the agent of any one of claims 1 to 8 with said animal or said pests.
